(19) United States
(12) Patent Application Publication
(10) Pub. No.: US 2021/0362251 A1
(43) Pub. Date: Nov. 25, 2021

(54) Tool Having a Cutting Edge Formed by a Plurality of Blade Elements

(71) Applicant: Bayerische Motoren Werke Aktiengesellschaft, Muenchen (DE)

(72) Inventors: Boris BEVC, Muenchen (DE); Robert KIRSCHNER, Olching (DE); Robert LINDACHER, Hilgertshausen-Tandern (DE); Dietmar OPEL, Moosburg a.d.Isar (DE)

(21) Appl. No.: 17/285,068

(22) PCT Filed: Sep. 25, 2019
(86) PCT No.: PCT/EP2019/075812

§ 371 Date: Apr. 13, 2021

(30) Foreign Application Priority Data
Oct. 23, 2018 (DE) 10 2018 126 283.3

(51) Int. Cl. B23D 35/00

(52) U.S. Cl. CPC B23D 35/001; B23D 35/002

(57) ABSTRACT

A tool for cutting a workpiece includes a first tool part, which has a first cutting edge formed by a plurality of first blade elements, and a second tool part, which is opposite the first tool part and has a second cutting edge. In order to cut the workpiece which can be arranged between the tool parts, the tool parts can be moved towards one another from an open position into a cutting position. A particular, separate receiving contour of the first tool part is associated with the relevant first blade element, which receiving contour corresponds to a particular external contour of the relevant first blade element, wherein the relevant first blade element is form-fittingly arranged at least predominantly in the associated receiving contour of the first tool part.

### BACKGROUND AND SUMMARY OF THE INVENTION

The invention relates to a tool for cutting a workpiece.

In the production, in particular series production, of motor vehicles, shearing, or blanking, is nowadays used to produce shaped sheet-metal parts, in particular vehicle-body structural elements. Shearing can be used to cut out blanks from a metal sheet (cutting out, punching), and/or to separate waste from the metal sheet (cutting off). For this purpose, normally, press-type cutting tools are used, which have one cutting knife or two mutually opposite cutting knives, the blades of which are milled and hardened. Consequently, when the cutting edge, or blades, become worn, they must either be completely replaced or material must be welded onto worn regions of the blades and then the corresponding blade must be sharpened by the removal of material, in particular by milling. On the one hand, this is particularly costly and/or time-consuming, thereby adversely affecting a production process of the motor vehicle. Furthermore, owing to the thermal action on a material of the blade, there is a risk of oxide formation and a detrimental structural change of the material of the blade, resulting in a risk of breakage of the blade.

To counter this problem, interchangeable blade systems are known from the prior art, in which a multiplicity of blade elements together form a cutting edge of the press-type tool. Thus, for example, DE 10 2005 007 676 B3 discloses an arrangement and fastening of cutting plates on a main body of a tool, having grooves arranged in the cutting plates and having fastening drill-holes arranged in the cutting plates and widening in an approximately conical shape, the cutting plates to be fastened to the main body of the tool being clamped to the main body of the tool by means of countersunk-head screws arranged in the fastening drill-holes, the tool cutting edges arranged on the main body of the tool each being formed by the cutting edges of a plurality of cutting plates arranged next to one another on a common supporting surface of the main body of the tool, and a guide rail, which corresponds to the groove and which engages in the grooves and on which the cutting plates are arranged, being arranged on the supporting surface of the cutting plates, on the main body of the tool.

Even just the forming of the groove in the cutting plates makes this conventional arrangement and fastening of cutting plates particularly complex. Furthermore, the cutting plates, especially in the region of the groove, have a reduced material thickness over a respective groove-free portion of the cutting plates, such that the cutting plates, at least in the region of the respective groove, are particularly unstable.

It is the object of the invention to provide a tool for cutting a workpiece, at least one cutting edge of which is particularly stable and is easily serviced.

This object is achieved according to the invention by a tool having the features of the independent claim. Advantageous embodiments of the invention are provided by the dependent claims and the description.

A tool according to the invention for cutting a workpiece comprises a first tool part, and a second tool part opposite the first tool part. The first tool part has a first cutting edge, which is formed from a plurality of first blade elements. The second tool part has a second cutting edge. This means that the first cutting edge has a multiplicity of first blade elements, and that the second cutting edge is formed by at least one second blade element.

For the purpose of cutting the workpiece that is arrangeable or arranged between the tool parts, the tool parts can be moved towards each other from an open position into a through-cutting position. Consequently, for the purpose of cutting the workpiece, the two tool parts are moved away from each other into the open position, the workpiece is arranged between the two tool parts and then the two tool parts are moved towards each other into the through-cutting position. This causes the cutting edges to penetrate a material of the workpiece and finally to cut through it.

In order then to make the cutting edge of the tool particularly stable and easy to service, the invention provides that the respective first blade element is assigned its own respective receiving contour of the first tool part corresponding to a respective outer contour of the respective first blade element, wherein the respective first blade element is arranged in a form-fitting manner, at least predominantly, in the respectively assigned receiving contour of the first tool part. Accordingly, a multiplicity of receiving contours is provided on the first tool part, such that the first cutting edge is produced by inserting respectively one of the first blade elements into the respective receiving contours of the first tool part. For this purpose, the respective receiving contour on the first tool part is directly adjacent to at least one other receiving contour of the same tool part. In particular, the respective receiving contours of the first tool part are arranged in such a manner that, when the first blade elements are inserted into the receiving contours, the first cutting edge at least substantially follows a straight line.

The first blade elements are each realized without a groove, and the receiving contours of the first tool part are realized without a respective rail, because the respective first blade element is held securely in position in the respective receiving contour of the first tool part, in that the outer contour of the respective first blade element fits closely against an inner contour of the receiving contour of the first tool part, at least regionally.

Consequently, the first cutting edge is particularly easy to repair and/or service. If the first cutting edge is worn and/or damaged, it is not necessary to completely remove the first cutting edge, as only the blade elements of the first cutting edge that are affected by the wear or damage need to be replaced. In addition, a costly and time-consuming application or welding of material onto the first cutting edge and subsequent grinding of the first cutting edge can be omitted, such that the time needed to repair or service the first cutting edge is particularly short. This consequently is advantageous for the production, in particular series production, of motor vehicles, because an unproductive, and therefore undesirable, downtime of the tool for repairing or servicing the first cutting edge of the tool is particularly short.

Particularly preferably, the second cutting edge is formed from a plurality of second blade elements, each of which is assigned its own respective receiving contour of the second tool part corresponding to a respective outer contour of the second blade element, wherein the respective second blade element is arranged in a form-fitting manner, at least predominantly, in the respectively assigned receiving contour of the second tool part. This means that the receiving contour of the first tool part is a first receiving contour, and that the receiving contour of the second tool part is a second receiving contour. The first receiving contour in this case corresponds to one of the first blade elements, and the second receiving contour corresponds to one of the second blade elements. As already described, the multiplicity of first receiving contours is then provided on the first tool part, and a multiplicity of second receiving contours is provided on the second tool part, such that the first and the second cutting edge result from one of the first and one of the second blade elements being in each case inserted into the respective receiving contours of the first and the second tool part. For this purpose, the respective receiving contour on the corresponding tool part is directly adjacent to at least one other receiving contour of the same tool part.

Consequently, the advantages mentioned in connection with the first cutting edge also apply analogously to the second cutting edge. In other words, the second cutting edge is also particularly easy to repair and/or service. As a result, the undesirable, unproductive downtime of the tool for repair or servicing the cutting edges is even shorter.

The second blade elements are similar to the first blade elements, and the second receiving contours are similar to the second receiving contours. In other words, the second blade elements are each realized without a groove, and the second receiving contours are realized without a respective rail, because the second blade elements are held securely in position in the respective second receiving contour, in that the respective second outer contour of the respective second blade element fits closely against an inner contour of the second receiving contour, at least regionally.

The respective receiving contours may be arranged in such a manner that, when the first or second blade elements are inserted into the receiving contours, the first and the second cutting edge at least substantially follow a straight line. However, the first and/or the second blade elements—irrespective of whether only one of the cutting edges is formed from a multiplicity of corresponding blade elements—may alternatively be embedded obliquely in the corresponding receiving contours. This means that the respective receiving contours can be positionally aligned in such a manner that the respective blade element is rotated about at least one of the three mutually perpendicular spatial axes in relation a tool closing direction along which the tool parts can be adjusted between the open position and the through-cutting position of the tool. In this way, three-dimensionally shaped cuts can be produced, in particular having a cut line that differs from a straight line. Furthermore, as a result of such an oblique position, at least one of the two cutting edges acts as a burnishing lug, such that burr formation can be influenced in a targeted manner during the cutting process.

It has been found to be advantageous, in particular, if the respective blade element is a straight prism having a polygon as its base. Accordingly, the respective outer contour is formed as a material recess in the respective tool part, the material recess of the receiving contour having a polygon, corresponding to the polygon of the blade element, as the base of the receiving contour. In other words, the respective receiving contour represents a negative shape of the respectively assigned blade element. The respective blade element at least predominantly received in the receiving contour has at least one edge region that in a straight and direct manner adjoins an edge region of a directly adjacent blade element, such that the two directly adjoining edge regions of the two blade elements at least partially form the respective cutting edge. For this purpose, the straight edge region forming the respective cutting edge and an edge region of the same blade element that is directly adjacent thereto each enclose an angle of at most 90 degrees with one another.

In this regard it is provided that the polygon has exclusively straight edges, which makes the blade element particularly easy to manufacture. Thus, the recess, or the receiving contour, can also be produced particularly easily and/or with little resource requirement by means of commonly known processes, in particular processes known from metal construction.

According to another embodiment, the respective blade element is realized so as to be symmetrical at least in relation to a plane perpendicular to the cutting edge. In particular, the respective blade element is arranged symmetrically in relation to the plane perpendicular to the cutting edge. This means that this plane perpendicular to the cutting edge forms a first plane of symmetry of the respective blade element. Accordingly, the respective blade element can be inserted in two different positions into the corresponding receiving contour; the respective blade element is thus realized as a reversible blade element. Consequently, the blade element realized in this manner can be inserted in at least two positions into the receiving contour. In other words, the blade element received in the receiving contour can be removed from it, rotated by 180 degrees about the axis of symmetry and then reinserted into the receiving contour. The blade element realized in this manner, when reversed, can be used on the tool in a particularly quick and easy manner, which—compared to a conventional tool—reduces the time required for repair or servicing of the respective cutting edge.

As a result, the respective blade element has a longer service life compared to a conventional blade element that can only be connected to a tool part in a single position.

Alternatively or additionally, the polygon may be laterally reversed or symmetrical in relation to a straight line of symmetry that is a parallel to the respective cutting edge. Consequently, the respective blade element is then symmetrical in relation to a second plane of symmetry, which intersects perpendicularly the first plane of symmetry, described above, and which runs parallel to a base of the respective receiving contour. If the blade element has the first and the second plane of symmetry, it can be inserted in four different positions into the corresponding receiving contour.

Again alternatively or additionally, a third plane of symmetry may be provided, which in each case is arranged perpendicularly in relation to the first and the second plane of symmetry. If the respective blade element has the first, the second and the third plane of symmetry, it can be inserted in eight different positions into the corresponding receiving contour.

It has been found to be particularly advantageous in this regard if the polygon is realized as an isosceles triangle. This means that the respective blade element is a straight prism, the base of which is the isosceles triangle. Since the receiving contour corresponds to the respective outer contour of the corresponding blade element, the respective receiving contour is accordingly a material recess realized in the respective tool part, the inner contour of which follows the prism having the isosceles triangle as its base. The respective blade element, the outer contour of which corresponds to the prism having the isosceles triangle as its base, is likewise a reversible blade element, as the respective blade element is laterally reversed in relation to a symmetry plane that intersects the respective cutting edge perpendicularly. Accordingly, this blade element can be rotated by 180 degrees about an axis that is perpendicular to the respective cutting edge and that lies in the plane of symmetry. Furthermore, when the respective blade element is pushed into the correspondingly realized receiving contour, the blade element is self-centered in the receiving contour and in relation to the receiving contour. In this way, it is particularly easy to ensure that the plurality of blade elements arranged directly next to each other form the respective cutting edge, which then runs particularly precisely straight.

In an alternative design, the polygon is a regular polygon, i.e. an isogon. For a cutting edge that is continuous and uninterrupted along a single straight line, the respective blade element is then a straight prism, the base of which is an equilateral triangle. In other words, the regular polygon, or isogon, that serves as the base of the blade element is the equilateral triangle. The correspondingly realized blade element having the equilateral triangle as its base offers a multiplicity of advantages. On the one hand, the blade element is particularly easy and/or inexpensive to produce, as it only has straight edges. Consequently, the corresponding blade element can be produced in a manner that is particularly sparing of material. On the other hand, according to generally applicable geometric rules, the equilateral triangle has three axes of symmetry about which the corresponding blade element can then be rotated by 180 degrees. Accordingly, the blade element can be arranged in six different positions in the correspondingly realized receiving contour. Accordingly, the blade element having the equilateral triangle as its base has a six times longer service life than a simple blade element that only has a single edge region for forming a cutting edge. Moreover, the advantages described in connection with the blade element having the isosceles triangle as its base apply analogously to the blade element having the equilateral triangle as its base.

A further design provides that the blade elements of the first tool part and the blade elements of the second tool part are arranged in a mutually offset manner along the cutting edges. This is because the respective cutting edge has a multiplicity of transition regions, where two directly adjacent blade elements adjoin one another. In the respective transition region, the respective cutting edge is thus minimally interrupted in each case, since the respective edge regions of the blade elements that form the cutting edge with each other are not connected to each other in a materially bonded manner. In other words, the two blade elements that are directly adjacent to one another are spaced apart from each other by a particularly small gap. The mutually offset arrangement of the blade elements of the two tool parts along the cutting edges avoids a situation in which two transition regions, in particular two gaps, are located opposite each other, between two blade elements that are directly adjacent to each other, during cutting-through of the workpiece. A particularly uniform cutting pattern on the workpiece is thus ensured, and during the cutting-through of the workpiece particularly little material of the workpiece is affected in the transition regions by mutually opposite gaps, because in such gaps, at least in part, plastic deformation and subsequent tearing of the workpiece would take place instead of cutting of the workpiece.

It has also been found to be advantageous if the tool has a fastening means, by means of which the respective blade element is fastened or can be fastened to the respective tool part, wherein the respective receiving contour has a first fastening element of the fastening means, and the respective blade element has a second fastening element of the fastening means corresponding to the first fastening element. In this way, the respective blade element can be or is held in the respective receiving contour in a particularly reliable manner, which ensures that the corresponding blade element does not unwantedly move out of the form-fit and adversely affect a cutting result.

In particular in this respect, the first fastening element is realized as a screw-element receiver, and the second fastening element as a through-opening that extends fully through the respective blade element. Furthermore, the fastening means then has a screw element corresponding to the through-opening and to the screw-element receiver. The respective blade element can be held, or is held, by this fastening means in a particularly reliable manner in the correspondingly realized receiving contour assigned to the respective blade element, in that the corresponding blade element is screwed, or can be screwed, into the respective receiving contour by means of the respective screw element acting in combination with the respective screw-element receiver. Moreover, the fastening means enables the respective blade element to be released from the receiving contour, or removed from the receiving contour, particularly easily, in particular non-destructively. Similarly, the fastening means enables the respective blade element to be reinserted into the correspondingly realized receiving contour particularly easily and/or with little effort, and to be fastened there. Accordingly, the fastening means facilitates particularly rapid and/or low-effort reversing, or changing, of the respective blade element.

The respective receiving contour may be produced, for example, by means of laser cutting. In this case, the receiving contour may have particularly small radii, in particular edges, along its inner contour. It must be ensured in this case that, when the corresponding blade element is inserted into the assigned receiving contour, in particular at a three-dimensional corner of the receiving contour, the latter is completely free of dirt, chips, etc., in order to insert the respective blade element into the corresponding receiving contour in a particularly precise manner.

The insertion of the respective blade element into the respective receiving contour may be simplified, according to an advantageous embodiment, if the respective receiving contour is connected to a recess that is widened relative to at least a part of the respective receiving contour and into which an edge of the respective blade element projects. When the respective blade element is inserted into the corresponding receiving contour, the dirt, chips, etc. can then move into the recess, and the blade element is inserted into the corresponding receiving contour in a particularly precise manner. It may be provided, for example, that any objects lying in the receiving contour, for instance the dirt, chips, etc., are cleared or displaced by means of the blade element to be inserted into the corresponding receiving contour, in particular are pushed or cleared into the recess. Furthermore, the recess offers the advantage that the inner contour of the receiving contour does not have three-dimensional inner corners, such that the receiving contour can be produced in a known manner with little effort by means of a material-removing machining process, for example milling.

Further features of the invention are given by the claims, the figures and the description of the figures. The features and combinations of features mentioned above in the description, as well as the features and combinations of features mentioned below in the description of the figures and/or only shown in the figures, can be used not only in the combination indicated in each case, but also in other combinations or on their own.

The invention is now explained in greater detail with reference to a preferred exemplary embodiment and with reference to the drawings.

### BRIEF DESCRIPTION OF THE DRAWINGS

FIG. 1 is a schematic and perspective representation of a tool for cutting a workpiece; and

FIG. 2 is a more detailed view of a sub-region of the tool shown in FIG. 1.

In the figures, elements that are identical or functionally identical are denoted by the same references.

### DETAILED DESCRIPTION OF THE DRAWINGS

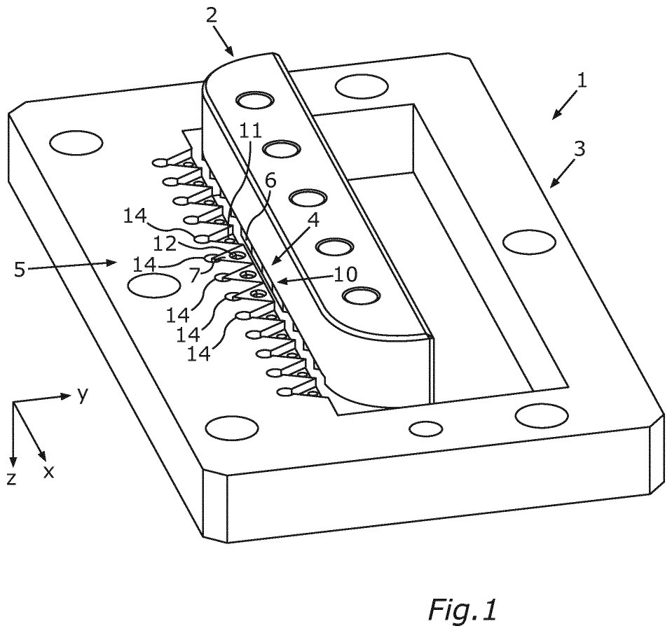

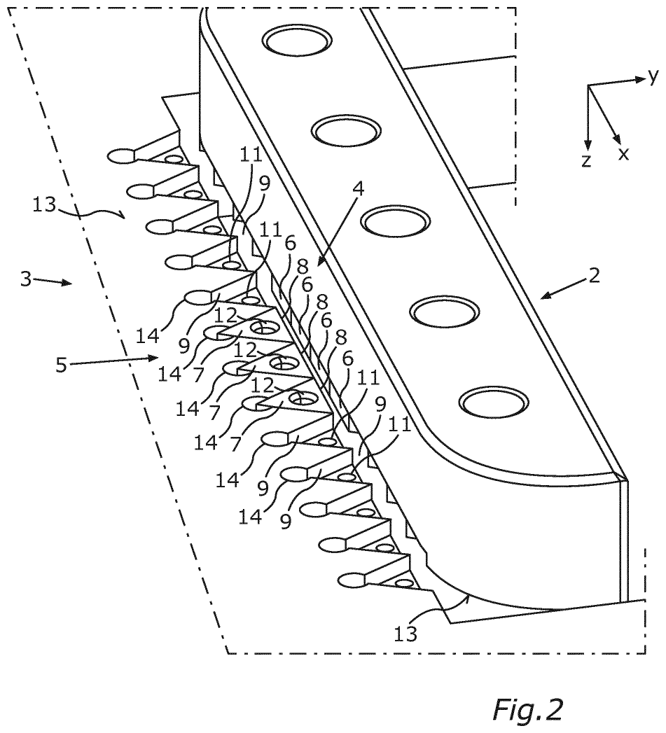

A tool 1, shown in a schematic, perspective representation in FIG. 1 and partially in greater detail in FIG. 2, is designed for cutting a workpiece, in particular a metallic workpiece, and has a first tool part 2 and a second tool part 3. The first tool part 2 has a first cutting edge 4, and the second tool part 3 has a second cutting edge 5. For the purpose of cutting the workpiece, for example initial cutting and/or cutting through, the tool 1, or the tool parts 2, 3, can be moved into an open position, in which it is possible to arrange, for example insert, the workpiece between the two tool parts 2, 3. The workpiece to be cut may be, for example, a plate-type shaped metal body, for example a metal sheet, coil ware, etc. When the workpiece is arranged between the tool parts 2, 3, or between the cutting edges 4, 5, the tool parts 2, 3 can be moved towards each other from the open position into a through-cutting position, as a result of which the cutting edges 4, 5 first plastically deform the workpiece and finally penetrate into the material of the workpiece, and subsequently finally cut through the workpiece. For this purpose, the tool parts 2, 3 can be moved towards each other along a tool closing direction. The tool closing direction may be, in particular, at least substantially parallel to a vertical direction z of the tool 1.

Since the tool 1 may be, in particular, a press-type cutting tool, it is provided in particular that the first tool part 2 and the second tool part 3 are opposite each other. Alternatively, it is contemplated for the two tool parts 2, 3 to be swivelable relative to each other about a common rotation axis, such that, when the material of the workpiece is being cut through, or severed, the cutting edges 4, 5 are at an angle in relation to each other.

The first cutting edge 4 is formed from a plurality of first blade elements 6, of which only a few are illustrated in the figure, for reasons of clarity. The second cutting edge 5 is formed from a plurality of second blade elements 7, of which only a few are shown in the illustration of the figure, for reasons of clarity. The respective blade elements 6, 7 each have at least one edge region 8, which at least partially forms the corresponding cutting edge 4, 5.

The respective blade element 6, 7 is assigned its own respective receiving contour 9, which corresponds to an outer contour of the respective blade element 6, 7. In other words, the first tool part 2 has a multiplicity of receiving contours 9, the respective receiving contour 9 of the first tool part 2 corresponding to the outer contour, i.e. to a shape of the respective first blade element 6. In addition, the second tool part 3 has a multiplicity of receiving contours 9, the respective receiving contour 9 of the second tool part 3 corresponding to the outer contour, or shape, of the respective second blade element 7. It is provided, in particular, that the first blade elements 6 and the second blade elements 7 are interchangeable, i.e. they are at least substantially identical. This means that the respective receiving contours 9 of the first tool part 2 correspond at least substantially to the respective receiving contours of the second tool part 3 in respect of their shape and/or their dimensions. In this way, advantageously, a set of spare parts for the tool 1 need be stocked only with a particularly small number of different spare parts.

Since the respective receiving contour 9 corresponds to the respective blade element 6, 7, the respective blade element 6, 7 is at least predominantly arranged in a form-fitting manner in the respectively assigned receiving contour 9. Accordingly, the respective blade element 6, 7 can be held, or is held, in a particularly stable position in the corresponding receiving contour 9.

In the present example, the respective receiving contour 9 is formed as a material recess from the respective tool part 2, 3. For example, the respective receiving contour 9, or the material recess, may be milled out of a material of the respective tool parts 2, 3, or otherwise separated out from the respective material of the respective tool parts 2, 3. Moreover, it is contemplated for the respective receiving contours 9 to be already produced, at least substantially, during a primary forming of the corresponding tool part 2, 3.

The respective blade element 6, 7 is realized as a straight prism having a polygon as its base, and the respective edge region 8 of the respective blade element 6, 7 is directly adjacent to the edge region 8 of the blade element 6, 7 adjacent to the respective blade element 6, 7. Consequently, two directly adjacent edge regions 8 of two blade elements 6, 7 at least partially form the respective cutting edge 4, 5. For this purpose, the straight edge region 8 forming the respective cutting edge 4, 5 and the edge regions of the same blade element directly adjacent thereto each enclose an angle of at most 90 degrees with each other, forming a corner. If a polygon is used as a base for the straight prism, this is particularly advantageous, as the polygon only has straight edges, which can be constructed, or produced, by particularly simple and/or particularly precise and commonly known processes (milling, beveling, sawing, cutting, etc.) and with a particularly small design and/or programming resource requirement (CNC: computerized numerical control). Furthermore, the edge regions 8, which are then also straight, are particularly easy to sharpen, resulting in a particularly sharp respective cutting edge 4, 5.

In order to reduce the servicing and/or repair time for the respective cutting edge 4, 5, the respective blade element 6, 7 and the corresponding receiving contour 9 may be realized so as to be symmetrical, at least with respect to a plane perpendicular to the respective cutting edge 4, 5. In this way, the respective blade element 6, 7 is realized as a reversible blade element, which has a particularly long service life, since it has at least one further edge region 8, which at least partially forms the respective cutting edge 4, 5 as soon as the corresponding blade element 6, 7 is inserted in the assigned receiving contour 9. Further planes, in relation to which the respective blade element 6, 7 is symmetrical or laterally reversed, are also conceivable. One of the further planes then runs perpendicular to the previously described plane, the tool closing direction z and the respective cutting edge 4, 5 coincide with this plane. With reference to the coordinate systems shown in figures, this is then an x-z plane. Moreover, the respective blade element 6, 7 may be laterally reversed, or symmetrical, with respect to a further plane, which in each case is perpendicular to the two previously described planes. Accordingly, the third plane is an x-y plane. There are thus obtained for the correspondingly realized blade element 6, 7 a plurality of possible installation positions, in which the respective blade element 6, 7 can in each case be arranged in the respective receiving contour 9. The more possible installation positions the respective blade element 6, 7 offers, the more edge regions of the respective blade element 6, 7 can be used as an edge region 8 partially forming a respective cutting edge 4, 5. Accordingly, the more possible installation positions the respective blade element 6, 7 offers, the longer the service life of the respective blade element 6, 7.

In the present example, the respective blade element 6, 7 is realized in the shape of a straight prism, the base of which is an isosceles triangle. Owing to the symmetry inherent in the isosceles triangle, the respective blade element 6, 7 realized in such a manner has two edge regions 8, and is particularly easy to insert into the correspondingly assigned and correspondingly realized receiving contour 9. Upon insertion of the blade element 6, 7, having the isosceles triangle as its base, the corresponding blade element 6, 7 is self-centered in relation to the receiving contour 9, and consequently in relation to the respective tool parts 2, 3.

Alternatively, the respective blade element 6, 7 may have the shape of a straight prism, the base of which is a regular polygon, particularly preferably an equilateral triangle. In contrast to the isosceles triangle, the equilateral triangle has three axes of symmetry, which intersect each other at a common geometric center of the equilateral triangle, such that the corresponding blade element 6, 7, having the equilateral triangle as its base, can be inserted in six possible positions into the correspondingly realized and assigned receiving contour 9. Furthermore, the respective blade element 6, 7 following the equilateral triangle has six edge regions 8.

As can be seen particularly easily from FIG. 1 and FIG. 2, the first blade elements 6 of the first tool part 2 and the second blade elements 7 of the second tool part 3 are arranged in a mutually offset manner along the cutting edges 4, 5. Transition regions in which the edge regions 8 of two directly adjacent blade elements 6, 7 directly adjoin each other are thereby prevented from being directly opposite each other along a transverse tool direction y.

Furthermore, a fastening device 10 may be provided, by means of which the respective blade element 6, 7 is fastened or can be fastened to the respective tool part 2, 3. The fastening device 10 has a first fastening element 11 and a second fastening element 12, which correspond to each other, and which—when acting in combination with each other—hold the correspondingly assigned blade element 6, 7 in the corresponding receiving contour 9. A clamping mechanism, for example, may be provided, which holds the corresponding blade element 6,7 securely in the respective receiving contour 9. This means that the first fastening element 11 may be realized as a clamping leg, while the second fastening element 12 may be realized as a bearing surface for the clamping leg that is specific to and corresponds to the clamping leg. Alternatively or additionally, it is conceivable for the corresponding blade element 6, 7 to be held in a force-fitting, form-fitting and/or materially bonded manner in the respective receiving contour 9 in a different way by the fastening means 10.

In the present example, the first fastening element 11 of the fastening device 10 is realized as a screw-element receiver 11 realized in the respective receiving contour 9, the second fastening element 12 of the fastening device 10 being realized as a through-opening 12 that extends fully through the respective blade element 6, 7. The screw-element receiver 11 may be realized, for example, as a blind hole which, starting from a bottom of the corresponding receiving contour 9, extends into the material of the corresponding tool part 2, 3. An inner circumferential surface of the blind hole, or of the screw-element receiver 11, advantageously has an internal thread. Furthermore, the fastening device 10 comprises a screw element, not represented, which corresponds to the through-opening 12 and the screw-element receiver 11, and has an external thread that corresponds to the internal thread of the screw-element receiver 11, or of the blind hole, such that the screw element can be screwed into the screw-element receiver 11. Since the screw element is supported by its head portion on the respective blade element 6, 7, extends fully through the respective blade element 6, 7 and extends further into the screw-element receiver 11, the respective blade element 6, 7 is clamped between the head portion and a base or a bottom surface of the respective receiving contour 9, and is thereby held firmly in position. It is provided, in particular, that the through-opening 12 is realized as a receiver for a tapered or frustoconical countersunk head of the screw element, such that the countersunk head can be at least substantially completely countersunk into the through-opening 12. This means that the head portion has a tapered or frustoconical outer contour that corresponds at least substantially with the receiver of the through-opening 12. Consequently, the screw element may be a screw, in particular a countersunk-head screw. This ensures that the screw element or the screw does not extend beyond a surface 13 of the respective tool part 2, 3.

In order to create a tolerance compensation between the corresponding receiving contour 9 and the respective blade element 6, 7 assigned to it, it is provided that the respective receiving contour 9 is connected to a recess 14 that is widened with respect to at least a part of the respective receiving contour 9. During manufacture of the respective tool parts 2, 3, or during manufacture of the respective receiving contour 9, the recess may be realized, for example, as a blind hole, the inner circumferential surface of which is open or interrupted and leads into the respective receiving contour 9. When the respective blade element 6, 7 is inserted as intended in the respective receiving contour 9, at least one edge of the respective blade element 6, 7 projects into the recess 14 connected to the corresponding receiving contour 9. In other words, the recess 14 at least partially encompasses the blade element 6, 7 inserted into the corresponding receiving contour 9.

Overall, the invention shows that the tool 1 for cutting the workpiece is equipped with a particularly stable cutting edge 4, 5, which is particularly easy to service or repair. In particular, in contrast to conventional cutting edges that need to be repaired, there is no thermal influence on the affected cutting edge, which occurs when material is welded onto the damaged cutting edge or onto a part of it. Furthermore, there is no need for reworking of the material welded onto the cutting edge to be repaired, in particular milling and/or sharpening, or grinding, of the corresponding cutting edge. It is to be noted in particular in this case that, for the repair or servicing of conventional cutting edges, the tool 1 is disadvantageously subjected to a down-time. On the other hand, during productive operation of the tool 1, a multiplicity of blade elements 6, 7 can already be kept in stock, which can then be easily turned or replaced in a particularly short down-time of the tool 1. In this way, the respective cutting edges 4, 5 of the tool 1 can be repaired, or serviced, particularly rapidly and easily, or with little effort.

In order to further facilitate the particularly simple repair or servicing, it may be provided, in particular, that the tool parts 2, 3 are realized so as to be congruent with each other, at least in the region of the respective cutting edges 4, 5. This means that blade elements 6, 7 that differ from each other do not have to be provided specifically for the respective tool parts 2, 3, but that the blade elements 6, 7 may be at least substantially identical, i.e. identical in geometry, identical in dimensions, identical in material, etc. In this way, the stock of spare parts for a tool 1 is significantly reduced. As a result, very little storage space is required to stock spare parts for the tool 1.

Another advantage is that the respective blade elements 6, 7 can be produced particularly easily and with little effort. In particular, it is provided that the respective blade elements 6, 7 are each formed at least substantially from a hard metal. Alternatively or additionally, the blade elements 6, 7 may have portions that comprise a material that is different from a metallic material, for example a plastic, a ceramic, etc.

### LIST OF REFERENCES

1 tool (die)
2 tool part
3 tool part
4 cutting edge
5 cutting edge
6 blade element
7 blade element
8 edge region
9 receiving contour
10 fastening device
11 screw-element receiver, or first fastening element
12 through-opening, or second fastening element
13 surface
14 recess

1.-10. (canceled)

11. A tool for cutting a workpiece, comprising:
a first tool part that has a first cutting edge and is formed from a plurality of first blade elements; and
a second tool part opposite the first tool part and having a second cutting edge, wherein,
for cutting the workpiece that is arrangeable between the tool parts, the tool parts are movable towards each other from an open position into a through-cutting position,
a respective first blade element is assigned its own respective receiving contour of the first tool part corresponding to a respective outer contour of the respective first blade element, and
the respective first blade element is arranged in a form-fitting manner, at least predominantly, in the respectively assigned receiving contour of the first tool part.

12. The tool according to claim 11, wherein
the second cutting edge is formed from a plurality of second blade elements, each of which is assigned its own respective receiving contour of the second tool part corresponding to a respective outer contour of the second blade element, and
a respective second blade element is arranged in a form-fitting manner, at least predominantly, in the respectively assigned receiving contour of the second tool part.

13. The tool according to claim 11, wherein
each respective blade element is a straight prism having a polygon as its base.

14. The tool according to claim 11, wherein
each respective blade element is configured so as to be symmetrical at least in relation to a plane perpendicular to the cutting edge.

15. The tool according to claim 13, wherein
the polygon is an isosceles triangle.

16. The tool according to claim 13, wherein
the polygon is a regular polygon.

17. The tool according to claim 13, wherein
the polygon is an equilateral triangle.

18. The tool according to claim 12, wherein
the first blade elements of the first tool part and the second blade elements of the second tool part are arranged in a mutually offset manner along the first and second cutting edges.

19. The tool according to claim 11, further comprising:
a fastener, by which the respective blade element is fastenable to the respective tool part, wherein the respective receiving contour has a first fastening element of the fastener, and the respective blade element has a second fastening element of the fastener corresponding to the first fastening element.

20. The tool according to claim 19, wherein
the first fastening element is configured as a screw-element receiver, and the second fastening element as a through-opening that extends fully through the respective blade element, wherein furthermore the fastener comprises a screw corresponding to the through-opening and to the screw-element receiver.

21. The tool according to claim 11, wherein
the respective receiving contour is connected to a recess that is widened relative to at least a part of the respective receiving contour and into which an edge of the respective blade element projects.
